(19) United States
(12) Patent Application Publication
(10) Pub. No.: US 2016/0224220 A1
(43) Pub. Date: Aug. 4, 2016

(54) SYSTEM AND METHOD FOR NAVIGATING BETWEEN USER INTERFACE SCREENS

(71) Applicant: Wipro Limited, Bangalore (IN)

(72) Inventor: Arnab Ganguly, Bangalore (IN)

(21) Appl. No.: 14/662,827

(22) Filed: Mar. 19, 2015

(30) Foreign Application Priority Data
Feb. 4, 2015 (IN) 564/CHE/2015

(51) Int. Cl. G06F 3/0484; G06F 3/041; G06F 3/0488

(52) U.S. Cl. CPC G06F 3/04845; G06F 3/0488; G06F 3/0414

(57) ABSTRACT

Embodiments of the present disclosure disclose a method for navigating between a plurality of user interface screens displayed on a display unit of a system. The method comprises sensing a touch pattern received from a user on a displayed user interface screen of the plurality of user interface screens of the system. Then, a touch force, duration and location of the touch pattern are determined. The system performs at least one of replacing the displayed user interface screen with a user interface screen from among the plurality of user interface screens stacked subsequent to the displayed user interface screen. The system performs merging one or more elements of the plurality of user interface screens with one or more displayed elements of the displayed user interface screen. The system performs toggling sequentially between each of the plurality of user interface screens.

This application claims the benefit of Indian Patent Application No. 564/CHE/2015 filed Feb. 4, 2015, which is hereby incorporated by reference in its entirety.

### TECHNICAL FIELD

The present subject matter is related, in general to navigation of user interface screens and more particularly, but not exclusively to a method and a system for navigating between a plurality of user interface screens.

### BACKGROUND

An electronic device, generally, a touch screen device is a device on which a user can make a touch pattern by using a marker. The touch screen device includes, but is not limited to, computer, laptop, tablet, smartphones, mobile devices and the like. The touch pattern includes, but is not limited to, swipe, slide, poke, tap, press, gestures, movements, motions etc. The marker includes, but is not limited to, stylus, pen, pencil, hand, finger, and pointing device, etc. The touch screen device comprises a plurality of user interface screens which are arranged in two-dimensional form. In such a case, the touch screen device provides two dimensional navigational options to navigate from one user interface screen to another user interface screen. The two dimensional navigational options include, but are not limited to, scrolling or sliding the user interface screen up or down i.e. scrolling or sliding in X axis or Y axis.

### SUMMARY

Disclosed herein are a method and a system for navigating between a plurality of user interface screens displayed on a display unit of the system. The method comprises sensing a touch pattern received from a user on a displayed user interface screen of the plurality of user interface screens of the system. Each of the plurality of user interface screens is vertically stacked. The method further comprises determining a touch force, duration and location of the touch pattern. The method further comprises performing replacing the displayed user interface screen with a user interface screen from among the plurality of user interface screens stacked subsequent to the displayed user interface screen. The method further comprises merging one or more elements of the plurality of user interface screens with one or more displayed elements of the displayed user interface screen. The method further comprises toggling sequentially between each of the plurality of user interface screens.

In an aspect of the present disclosure, a system for navigating between a plurality of user interface screens displayed on a display unit of the system is disclosed. The system is a touch screen device having a touch screen panel and/or touch pad. The system comprises a processor and a memory communicatively coupled to the processor. The memory stores processor-executable instructions, which, on execution, cause the processor to perform one or more acts. The processor is configured to sense a touch pattern received from a user on a displayed user interface screen of the plurality of user interface screens of the electronic device. The processor is configured to determine a touch force, duration and location of the touch pattern. Further, the processor is configured to perform at least one of replace the displayed user interface screen with a user interface screen from among the plurality of user interface screens stacked subsequent to the displayed user interface screen. The processor is further configured to merge one or more elements of the plurality of user interface screens with one or more displayed elements of the displayed user interface screen. The processor is further configured to toggle sequentially between each of the plurality of user interface screens.

In another aspect of the present disclosure, a non-transitory computer readable medium for navigating between a plurality of user interface screens displayed on a display unit of the system is disclosed. The non-transitory computer readable medium includes instructions stored thereon that when processed by a processor causes a system to perform operations comprising sensing a touch pattern which is received from a user on a displayed user interface screen of a plurality of user interface screens of the electronic device. The operations comprise determining a touch force, duration and location of the touch pattern. The operation comprises performing at least one of replacing the displayed user interface screen with a user interface screen from among the plurality of user interface screens stacked subsequent to the displayed user interface screen. Further, the operation comprises merging one or more elements of the plurality of user interface screens with one or more displayed elements of the displayed user interface screen. Further, the operation comprises toggling sequentially between each of the plurality of user interface screens.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1a illustrates a block diagram of an exemplary system with processor and memory in accordance with some embodiments of the present disclosure;

FIG. 1b illustrates a block diagram of an exemplary system to navigate between a plurality of user interface screens in accordance with some embodiments of the present disclosure;

FIG. 2a illustrates exemplary plurality of user interface screens stacked vertically in Z-axis of a system in accordance with some embodiments of the present disclosure;

FIG. 2b shows one or more elements of a plurality of user interface screens in accordance with some embodiments of the present disclosure;

FIG. 3a shows an exemplary diagram illustrating an amount of force applied by a user on user interface screen in accordance with some embodiments of the present disclosure;

FIG. 3b shows an exemplary diagram illustrating navigation along Z-axis based on touch force applied along Z-axis in accordance with some embodiments of the present disclosure;

FIG. 3c shows an exemplary diagram illustrating replacing of displayed user interface screen with a user interface screen of the plurality of user interface screens stacked subsequent to the displayed user interface screen in accordance with some embodiments of the present disclosure;

FIGS. 4a and 4b shows an exemplary diagrams illustrating merging one or more elements of the plurality of user interface screens with one or more displayed elements of the displayed user interface screen in accordance with some embodiments of the present disclosure;

FIGS. 5a to 5c show a flowchart illustrating a method for navigating between a plurality of user interface screens displayed on a display unit of a system in accordance with some embodiments of the present disclosure; and

FIG. 6 illustrates a block diagram of an exemplary computer system for implementing embodiments consistent with the present disclosure.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

In scenarios, where touch screen devices comprise multiple interface screen, navigation from one interface to another interface screen may be performed in or more ways by conventional techniques. In an example, considering the touch screen device comprising five user interface screens where assuming n1 is the user interface screen which is currently displayed(in focus) on a display unit of the touch screen device. Further, the user interface screens n2, n3, n4 and n5 are virtually stacked one after the other. The user interface screens n2, n3, n4 and n5 can be displayed currently on the display unit when the user scrolls from n1 user interface screen to the user interface screens n2, n3, n4 and n5 sequentially. Specifically, assuming the user wishes to navigate to user interface screen n5. In such a case, the user has to scroll from user interface screen n1 through user interface screens n2, n3 and n4 sequentially to reach user interface screen n5. Upon scrolling to user interface screen n5 through the user interface screens n2, n3 and n4 from the user interface screen n1, the user interface screen n5 is displayed currently on the display unit of the electronic device. However, scrolling or sliding up or down through the user interface screens is a tedious, cumbersome, inefficient and time consuming. For example, navigating from one user interface screen i.e. n1 to another i.e. n5 through a sequence of intermediate user interface screens i.e. n2, n3 and n4 is tedious and creates a significant cognitive burden on the user.

In one conventional approach, the user has to come to default user interface screen of the touch screen device for navigating from the currently displayed user interface screen to another user interface screen. For example, let ‘D’ be default user interface screen and assuming the user is accessing user interface screen n1. For navigating to user interface screen n3, the user has to come back to ‘D’ default user interface screen from the user interface screen n1. Then, the user has to scroll to user interface screen n3 through intermediate user interface screen n2 to access the user interface screen n3. Such navigation is time consuming and involves multiple steps for navigation.

Further, size of the user interface screens is different in different electronic devices. Also, currently, some of the touch screen devices are designed with user interface screens having smaller size for example, smartwatch. Such smaller sized user interface screens limits performing two dimensional navigational options which is usually involves difficulty and cumbersome. Also, there exists a problem in virtually stacking various user interface screens one after the other in X axis or Y axis of the touch screen devices. In such a case, one or more applications present in the user interface screen for example, email application, Internet application, message application etc. must be configured in single user interface screen. Therefore, there exists a problem in accessing the one or more applications by the user in such smaller sized user interface screen.

Further, in another conventional approach, access to one or more applications of the user interface screen may be obtained by using one or more external peripheral devices, for example keyboard and/or mouse. However, cost of using the one or more external peripheral devices is not economical. Also, there exists complexity in connecting the one or more external peripheral devices with the touch screen device.

Embodiments of the present disclosure are related to a method and a system for navigating between user interface screens. The user interface screens are vertically stacked one after the other on the system for example touch screen device having touch screen panel and/or touch pad. The method comprises detecting a touch pattern received from a user on a displayed user interface screen i.e. the user interface screen which is interactive with the user in a current time. Then, a touch pressure of the touch pattern exerted by the user is determined. Also, duration of the touch pattern and location at which the touch pattern is received from the user is determined along with determining the touch pressure. Based on the touch pressure, duration and the location of the touch pattern, one or more operations are performed. Particularly, when touch force is greater than a predefined touch force and the duration of the touch pattern is less than a predetermined time, the displayed user interface screen is replaced with a user interface screen which is stacked subsequent to the displayed user interface screen. If the touch force is greater than the predefined touch force, the duration is less than the predetermined time and the location of the touch pattern is one or more displayed elements of the displayed user interface screen, then one or more elements of the plurality of user interface screens are merged with the one or more displayed elements. If the touch force is greater than the predefined touch force and the duration of the touch pattern is greater than the predetermined time, then each of the plurality of user interface screens are toggled sequentially in a continuous manner until release of the touch pattern from the displayed user interface screen is detected.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

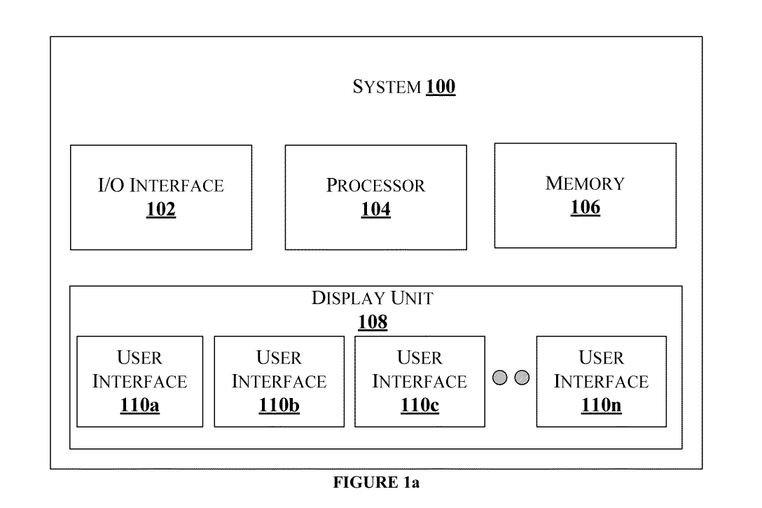

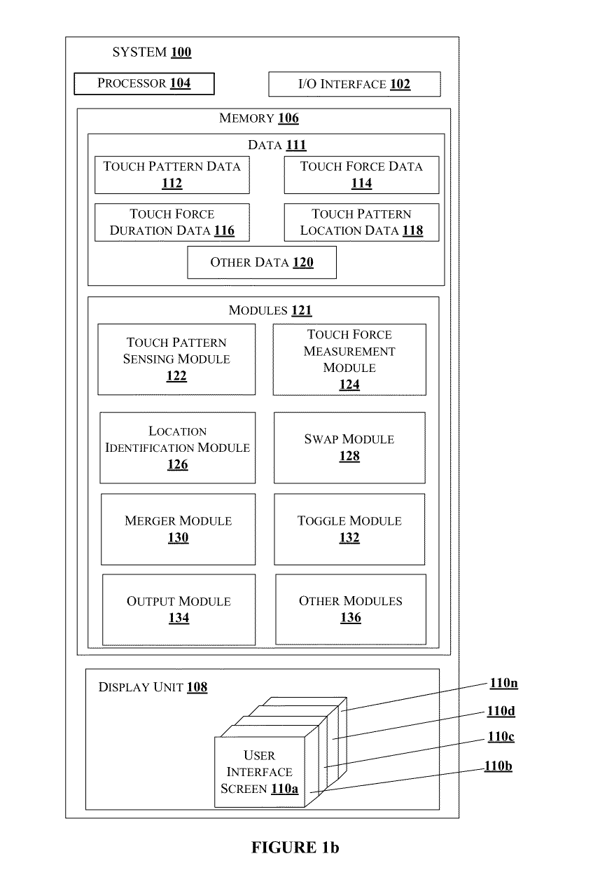

FIG. 1a illustrates a block diagram of an exemplary computing device or system 100 with processor 104 and memory 106 in accordance with some embodiments of the present disclosure.

Examples of the system 100 includes, but is not limited to, mobiles phones, Personal Computers (PC), desktop computer, laptop, tablet, smartwatch, cameras, notebook, pager, cellular devices, Personal Digital Assistant (PDA), Global Positioning System (GPS) receivers, Television (TV) remote controls, audio- and video-file players (e.g., MP3 players and iPODs), digital cameras, and e-book readers (e.g., Kindles and Nooks), smartphone, server computers, mainframe computers, network PC, wearable device and the like. The system 100 refers to a touch screen device having a touch screen panel (not shown). In an embodiment, the system 100 refers to such device having a touch pad (not shown).

The system 100 comprises the processor 104, the memory 106, and a display unit 108 comprising a plurality of user interface 110a, 110b, 100c, . . . , 110n. The configuration and functioning of each of the processor 104, the memory 106, the display unit 108 and the plurality of user interface 110a, 110b, 100c, . . . , 110n are explained in detail in following description of the disclosure.

FIG. 1b illustrates a block diagram of an exemplary system 100 to navigate between a plurality of user interface screens 110a, 110b, 110c, 110d, . . . , 110n (collectively referred to 110), in accordance with some embodiments of the present disclosure.

The system 100 comprises the plurality of user interface screens 110.

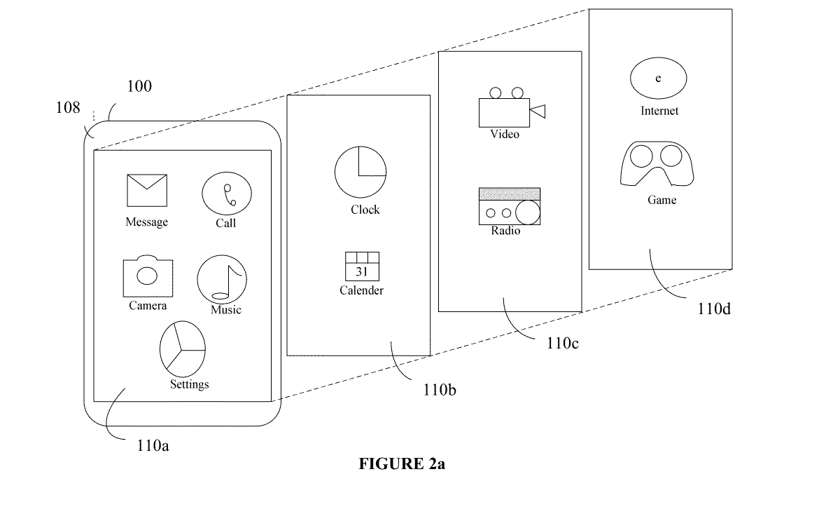

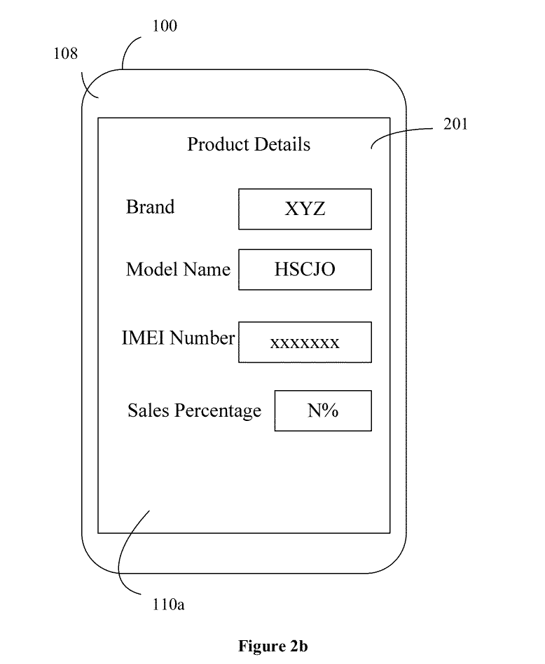

In an embodiment, the plurality of user interface screens 110 is a touch sensitive Graphical User interface (GUI). Particularly, each of the plurality of user interface screens 110 is configured to enable a user to input a touch pattern, and display a result of navigation performed based on the touch pattern inputted by the user. In an embodiment, the each of the plurality of user interface screens 110 is vertically stacked one after the other. There can be ‘n’ number of user interface screens 110 which are stacked vertically in different layers in a Z-axis perpendicular to a plane of the user interface screens 110. In FIG. 1b, the display unit 108 having ‘n’ number of user interface screens 110a, 110b, . . . , 110n are shown. Exemplary diagram showing vertically stacking of the plurality of user interface screens 110 in the Z-axis perpendicular to the plane of a displayed user interface screen 110a is illustrated in FIG. 2a. In the illustrative FIG. 2a, the user interface screen 110a is displayed currently on the display unit 108 and hence the user interface screen 110a is named as displayed user interface screen 110a. In an embodiment, any user interface screen which is displayed on top most layer accessible directly by the user is referred as displayed user interface screen. The user interface screen 110b is stacked in a second layer and behind the displayed user interface screen 110a in Z-axis perpendicular to the displayed user interface screen 110a. The user interface screen 110c is stacked in a third layer and behind the user interface screen 110b in Z-axis perpendicular to the user interface screen 110b and so on. In an embodiment, one or more user interface screens of the plurality of user interface screens 110 comprise one or more elements. The one or more elements can be icons on the corresponding user interface screens 110. For example, in the FIG. 2a, the displayed user interface screen 110a comprises the one or more elements namely “message”, “call”, “camera”, “music” and “settings”. The one or more elements of the displayed user interface screen 110a are referred as one or more displayed elements because the one or more elements of the displayed user interface screen 110a are currently viewable by the user. Likewise, the user interface screen 110b behind which is subsequent to the displayed user interface 110a comprises one or more elements namely “clock” and “calendar”. The user interface screen 110c behind the user interface screen 110b comprises one or more elements namely “video” and “radio” and the user interface screen 110d behind the user interface screen 110c comprises “Internet” and “game” as one or more elements. In another example, FIG. 2b shows product details 201 on the user interface screen 110a. The product details comprise elements namely “Brand”, “Model Name”, “IMEI-International Mobile Equipment Identity” and “Sales Percentage” displayed on the user interface screen 110a. A person skilled in art must understand that there can be any number and variety of elements on the multiple user interface screens 110.

In one implementation, the touch pattern includes, but is not limited to, swipe, slide, poke, tap, press, pinch, gestures, movements, motions etc. The touch pattern includes such patterns which are enabled by the plurality of user interface screens 110 having GUI. In an embodiment, the user can input the touch pattern using a marker which includes, but is not limited to, stylus, pen, pencil, hand, finger, and pointing device, etc. In an embodiment, each of the plurality of the user interface screens 110 includes one or more sensors (not shown) which is a touch capacitive sensor. The one or more sensor is configured to sense the touch pattern inputted by the user. In one implementation, the one or more sensor is configured to sense a touch force exerted by the user while inputting the touch pattern. Further, the one or more sensor is configured to sense duration and location of the touch pattern. For example, the one or more sensor is configured to measure a value of the touch force along with measuring the duration for which the touch pattern is inputted by the user. The one or more sensor is configured to determine location at which the touch pattern is sensed. For example, the one or more sensor is configured to determine whether the touch pattern is sensed on the displayed user interface screen 110a and/or on the one or more displayed elements of the displayed user interface 110a.

The system 100 may include input/output (I/O) interface 102, at least one central processing unit (“CPU” or “processor”) 104 and the memory 106 storing instructions executable by the at least one processor 104. The I/O interface 102 is coupled with the processor 104 through which the touch patterns along with the touch force is received which are inputted by the user on the displayed user interface screen 110. The I/O interface 102 is further configured to provide the result of the navigation to the displayed user interface screen 110a for display. The processor 104 may comprise at least one data processor for executing program components for executing user- or device-generated touch patterns. The user may include a person, a person using a device such as those included in this disclosure. The processor 104 is configured to receive the touch pattern from the one or more sensors through the I/O interface 102. The processor 104 is configured to determine the amount of the touch force exerted by the user with the touch pattern and location of the touch pattern. Then, the processor 104 is configured to perform navigational operations based on the amount of the touch force and location of the touch pattern. The processor 104 provides the result of the navigation to the display unit 108. The processor 104 performs the navigational operations using one or more data 111 stored in the memory 106.

In an embodiment, the one or more data 111 may include, for example, touch pattern data 112, touch force data 114, touch force duration data 116, touch pattern location data 118 and other data 120. In an embodiment, the one or more data are preconfigured to perform navigation between the plurality of user interface screens 110.

The touch pattern data 112 refers to data having the touch pattern sensed by the one or more sensor. For example, the swipe pattern is preconfigured based on which the navigational operations are performed by the processor 104. Upon receiving the swipe pattern from the user, the processor 104 performs navigational operations.

The touch force data 114 refers to predetermined amount of touch force required to be exerted by the user while inputting the touch pattern. For example, considering the user performs poke touch pattern with the touch force of ‘F′’ units. The touch force of ‘F’ units is the amount of the touch force which is considered to be the touch force data 114.

The touch force duration data 116 refers to duration for which the touch pattern is sensed by the one or more sensors. For example, assuming the poke touch pattern is sensed for 30 seconds continuously. Then, the duration of 30 seconds is considered as the touch force duration data 116. In an embodiment, the touch force duration data 116 is a time component based on which the processor 104 performs predetermined navigational operations.

The touch pattern location data 118 refers to data containing location at which the touch pattern is detectable by the one or more sensors. For example, assuming the touch pattern is inputted on the displayed element “message”. Then, the location here is considered to be the element “message” at which the touch pattern is detected.

The other data 120 may refer to such data which can be preconfigured in the system 100 for enabling the navigational operations.

In an embodiment, the one or more data 111 in the memory 106 are processed by one or more module(s) 121 of the system 100. The modules 121 may be stored within the memory 106 as shown in FIG. 1b. In an example, the one or more modules 121, communicatively coupled to the processor 104, may also be present outside the memory 106. Particularly, the one or more data 111 in the memory 106 including the touch pattern, the touch force data and the duration data are used by the one or more modules 121. In an embodiment, the one or more modules 121 are implemented and executed by the processor 104. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

In one implementation, the one or more modules 121 may include, for example, touch pattern sensing module 122, touch force measurement module 124, location identification module 126, swap module 128, merger module 130, toggle module 132 and output module 134. The memory 106 may also comprise other modules 136 to perform various miscellaneous functionalities of the system 100. It will be appreciated that such aforementioned modules may be represented as a single module or a combination of different modules.

In an embodiment, the touch pattern sensing module 122 senses the touch pattern received from the one or more sensors. The touch pattern is received from the user on the displayed user interface screen of the plurality of user interface screens 110 through the I/O interface 102. For example, considering the user inputs poke touch pattern on the displayed user interface screen 110a. The poke touch pattern is sensed by the one or more sensors which is in turn received by the touch pattern sensing module 122. In an embodiment, the touch pattern sensing module 122 determines whether the received touch pattern is matching with the preconfigured touch pattern data 112 stored in the memory 106 to perform navigational operations.

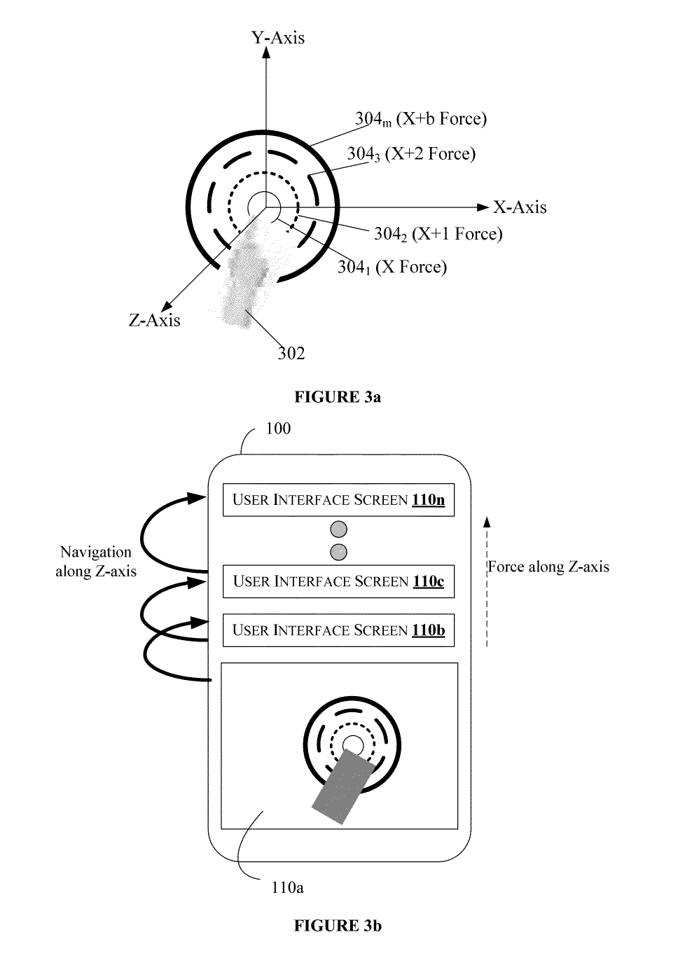

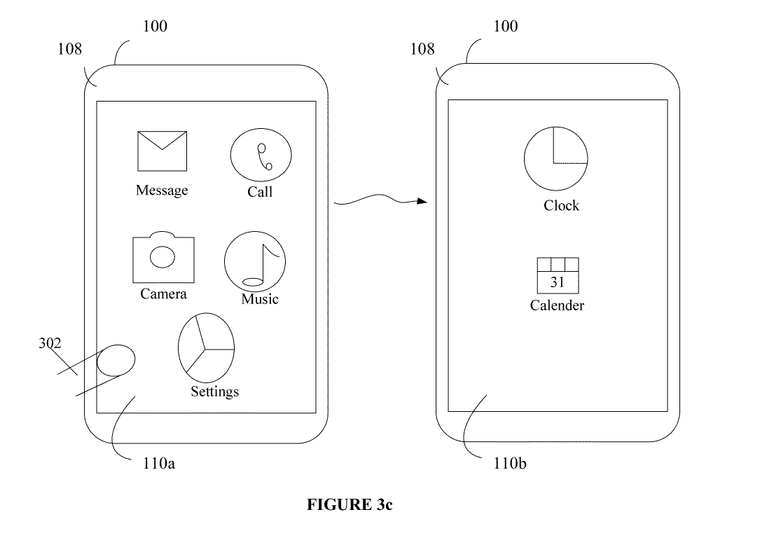

The touch force measurement module 124 is configured to determine the touch force of the touch pattern. Particularly, the touch force measurement module 124 evaluates the amount of the touch force exerted by the user while inputting the touch pattern. For example, assuming the amount of the touch force applied by the user is ‘F’ units which is measured by the touch force measurement module 124. FIG. 3a shows the amount of the touch force applied by the user in a form of concentric circles, as an example. Each of the concentric circles corresponds to amount of touch force. Particularly, when a certain amount of touch force is applied, then a corresponding concentric circle is displayed. Considering, the user applies the touch force of ‘X’ units. The touch force of ‘X’ units is viewable by the user when the inner most circle 304₁ is displayed. The touch force of ‘X+1’ units applied by the user is viewable by a second circle 304₂ subsequent to the inner most circle and so on. In an embodiment, there can be ‘b’ number of amount of touch force applicable on the user interface screens depicted as ‘X+b’ units. Additionally, there can be ‘m’ number of concentric circles configured depicted as 304. In an embodiment, the touch force measurement module 124 measures duration for which the touch pattern is received from the user. For example, assuming the poke touch pattern is sensed for 4 seconds continuously. Then, the duration of 4 seconds is considered as the duration of the touch pattern. Based on the amount of the touch force and the duration in the Z-axis and also location, the navigational operations are performs between user interface screens in Z-axis as shown in FIG. 3b.

The location identification module 126 identifies location at which the touch pattern is received. Particularly, the location identification module 126 identifies whether the touch pattern is received on the one or more elements of the displayed plurality of user interface screen 110.

The swap module 128 is configured to replace the displayed user interface screen 11a with a user interface screen of the plurality of user interface screens stacked subsequent to the displayed user interface screen 110a which is the user interface screen 110b. In an embodiment, the displayed user interface screen 110a is replaced with the user interface screen 110b when the amount of touch force is greater than a predetermined amount of touch force stored as touch force data 114 and when the duration of the touch pattern is less than the predetermined time contained in the touch force duration data 116. FIG. 3c shows an exemplary diagram illustrating replacing of displayed user interface screen 110a with the user interface screen 110b stacked subsequent to the displayed user interface screen 110a. For example, considering the amount of touch force predetermined is ‘X’ and predetermined time set is 5 seconds. Now, assuming the amount of touch force applied by user in real-time is ‘X+1’ with duration of the poke touch pattern is 2 seconds. The amount of touch force ‘X+1’ is greater than the predetermined amount of touch force ‘X’ and the duration of the touch pattern of 2 seconds is less than the predetermined time of 5 seconds. Hence, the swap module 128 replaces the displayed user interface screen 110a with the subsequent user interface screen 110b. In an embodiment, after replacing, the displayed user interface screen 110a becomes translucent and the subsequent user interface screen 110b/110d is displayed on the system 100. In an embodiment, any user interface screen subsequent to the displayed user interface screen 110a can be replaced. For example, the displayed user interface screen 110a can be replaced with the user interface screen 110d. In an embodiment, the displayed user interface 110a is replaced with corresponding user interface screen depending upon the amount of touch force is applied. For example, when the touch force of “X+1” is applied, then user interface screen 110c is displayed making the displayed user interface screen translucent.

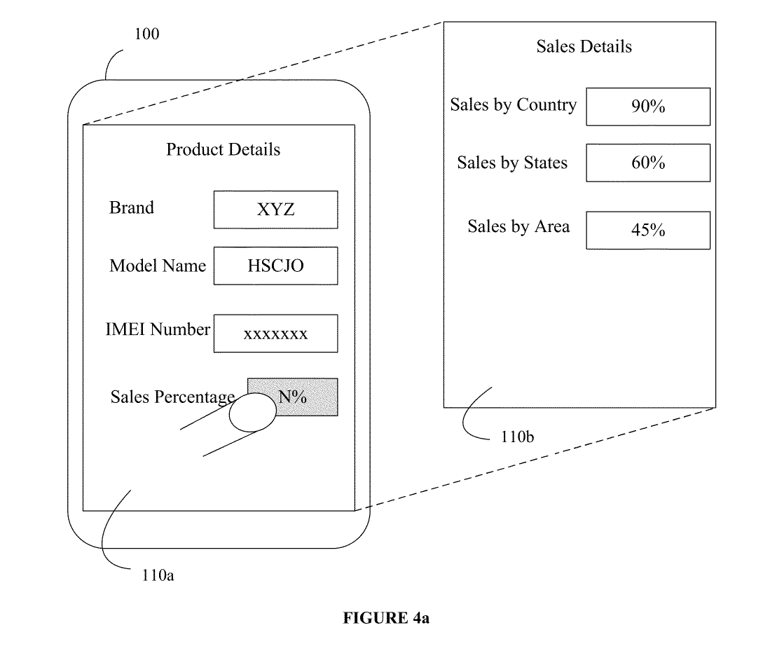

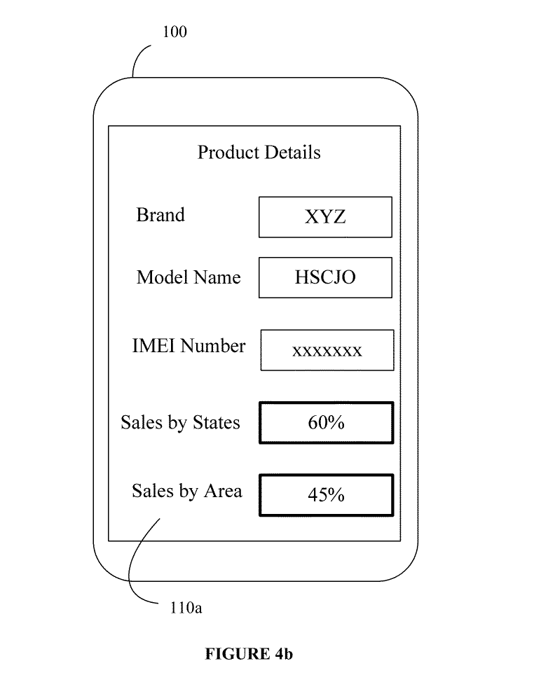

The merger module 130 is configured to merge one or more elements of the plurality of user interface screens 110 with one or more displayed elements of the displayed user interface screen 110a. In an embodiment, the one or more elements are merged with the one or more displayed elements when the amount of touch force applied by the user is greater than the predetermined amount of touch force, the duration is less than the predetermined time and the location of the touch pattern is at the one or more displayed elements of the displayed user interface screen 110a. In an embodiment, the merging is performed based on configuration by the user and/or based on application type. FIG. 4a shows an exemplary diagram illustrating merging of the one or more elements of the plurality of user interface screens 110 with the one or more displayed elements of the displayed user interface screen 110a. For example, the one or more elements of the “product” details on the displayed user interface screen 110a and “sales” details on another user interface screen 110b are merged. The “product” details comprises “brand”, “model name”, “IMEI number” and “sales” as the one or more displayed elements. The “sales” details on the user interface screen 110b comprises “sales by country”, “sales by states”, “sales by area” as the one or more elements. Assuming, the user wishes to view the sales percentage and thus selects the “sales” element on the displayed user interface screen 110a. Now, as per preconfigured and/or user requirement, the element “sales” is replaced with “sales by states” and “sales by area” which are usually required for the user as shown in FIG. 4b. In an embodiment, multiple elements from multiple user interface screens can be merged by the merge module 130.

The toggle module 132 is configured to toggle sequentially between each of the plurality of user interface screens 110. In an embodiment, the toggle module 132 toggles each of the plurality of user interface screens 110 sequentially when the amount of touch force is greater than the predetermined amount of touch force and the duration of the touch pattern is greater than the predetermined time or when the touch pattern is continuously sensed. In an embodiment, the toggle module 132 terminates upon sensing a release of the touch pattern from the displayed user interface screen 110a. For example, each of the user interface screens keeps toggling continuously between each other until the release of the touch pattern off from the displayed user interface screen 110a is detected. In an embodiment, one or more user interface screens among the plurality of user interface screen 110 can be configured or selected to be involved in toggling.

The output module 134 provides the result of the navigation to the display unit 108 to display the replaced user interface screen lib, and/or the merged elements and/or toggling of the plurality of user interface screens 110. Other modules 136 processes all such operations required to navigate between the plurality of user interface screens 110.

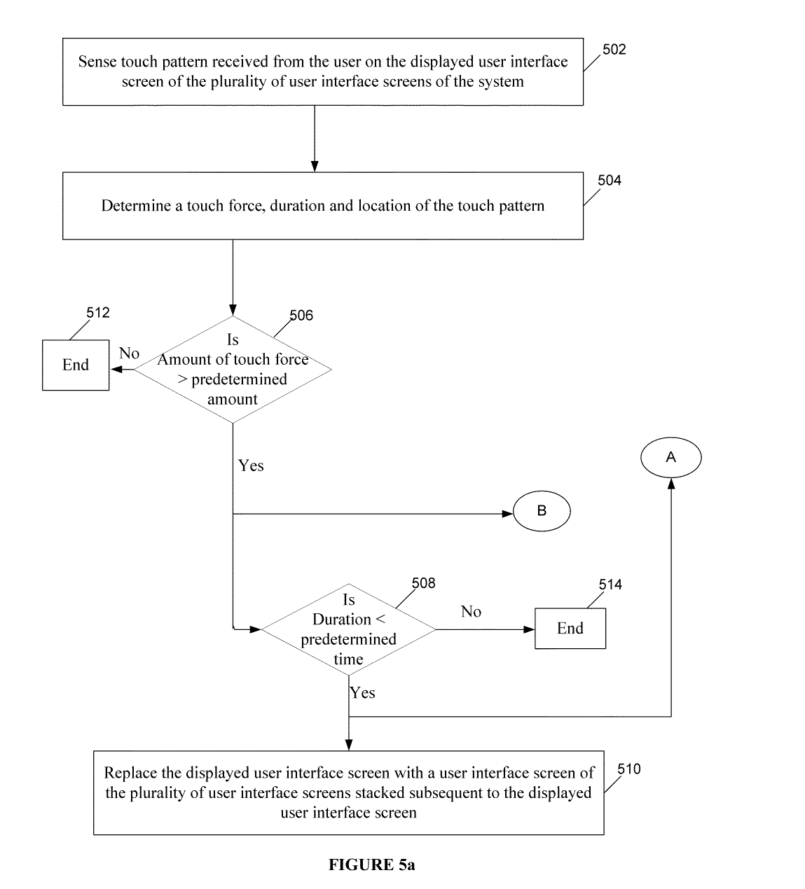

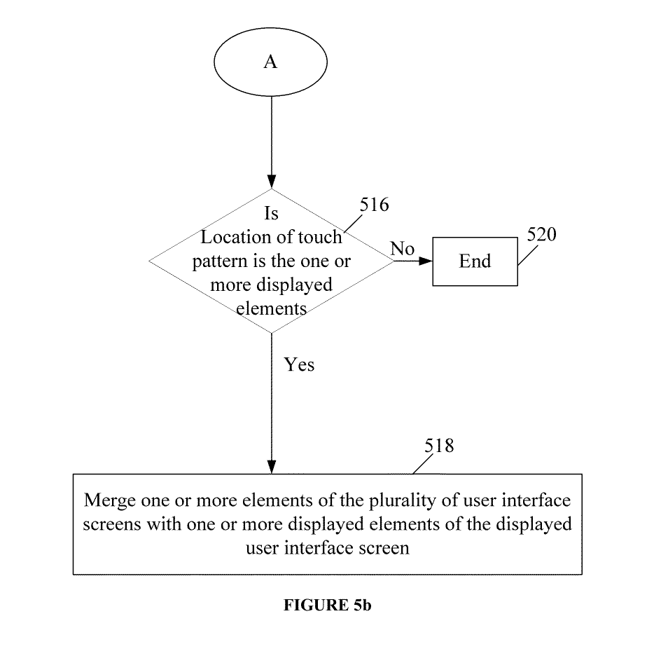

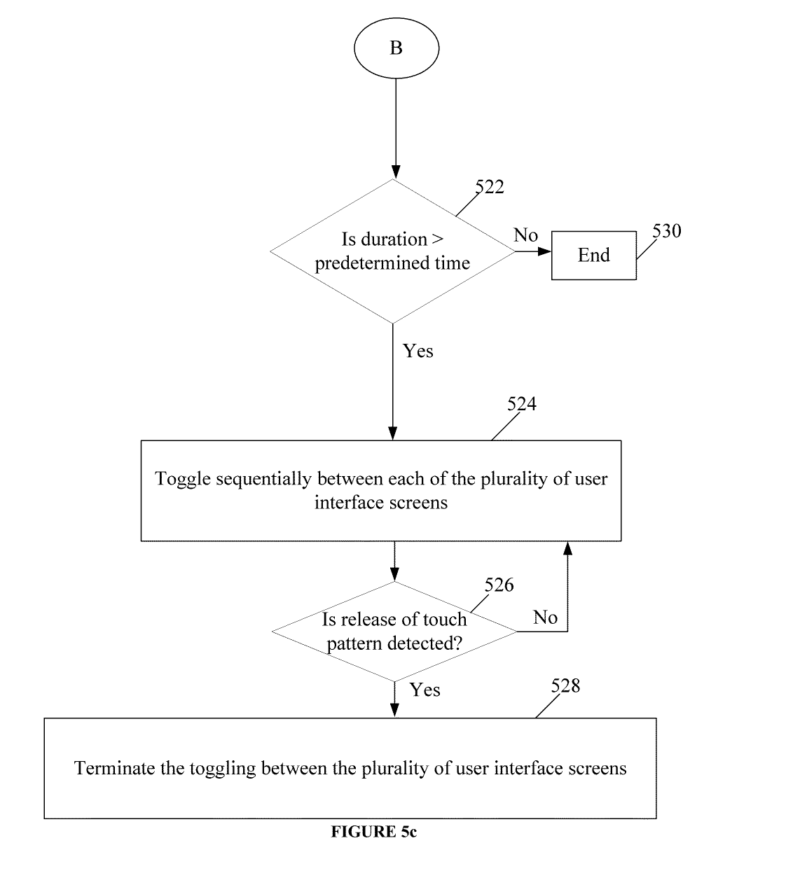

FIGS. 5a to 5c shows a flowchart illustrating a method for navigating between the plurality of user interface screens 131 displayed on the display unit 130 of the system 100 in accordance with some embodiments of the present disclosure.

As illustrated in FIGS. 5a-5c, the method comprises one or more blocks for storing a pattern for navigating between the plurality of user interface screens 110 displayed on the display unit 108 of the system 100. The method may be described in the general context of computer executable instructions. Generally, computer executable instructions can include routines, programs, objects, components, data structures, procedures, modules, and functions, which perform particular functions or implement particular abstract data types.

The order in which the method is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 502, the system 100 senses the touch pattern received from the user on the displayed user interface screen 110a of the plurality of user interface screens 110 of the system 100. In an embodiment, the system 100 senses the touch pattern using the one or more sensors (not shown) on the displayed user interface screen 110a.

At block 504, the system 100 determines touch force, touch duration and location of the touch pattern. In an embodiment, based on the touch force, the duration and the location of the touch pattern, the system 100 performs navigational operations. Particularly, the process goes to block 506.

At block 506, the system 100 checks whether the amount of touch force applied by the user is greater than the predetermined amount of touch force. If the amount of touch force applied is not greater than the predetermined amount of touch force, then the process goes to block 512 via “No” where the process ends. If the amount of touch force applied is greater than the predetermined amount of touch force, then the process goes to blocks B and 508.

At block 508, the system 100 checks whether the duration of the touch pattern received from the user is less than the predetermined time stored in the memory 106. If the duration of the touch pattern is not less than the predetermined time, then the process stops at block 514 via “No”. If the duration of the touch pattern is less than the predetermined time, then the process goes to blocks 510 and B via “Yes”. At block 510, the displayed user interface screen 110a is replaced with the user interface screen 110b stacked subsequent to the displayed user interface screen 110a.

In FIG. 5b, at block 516, the system 100 checks whether the location of the touch pattern is the one or more displayed elements of the displayed user interface screen 110a. If the location of the touch pattern is the one or more displayed elements, then the process goes to block 518. At block 518, the one or more displayed elements are merged with one or more elements of the plurality of user interface screens 110. In an embodiment, the merged one or more elements and the one or more displayed elements are displayed on the displayed user interface screen 110a. If the location of the touch pattern is not the one or more displayed elements, then the process stops at block 520 via “No”.

In FIG. 5c, at block 522, the system 100 checks whether the duration of the touch pattern is greater than the predetermined time or whether the touch pattern is continuously detected on the displayed user interface screen 110a. If the duration of the touch pattern is not greater than the predetermined time or whether the touch pattern is not continuously detected on the displayed user interface screen 110a, then the process stops at block 520 via “No”. If the duration of the touch pattern is greater than the predetermined time or whether the touch pattern is continuously detected on the displayed user interface screen 110a, then the process goes to block 524 via “Yes”. At block 524, the toggling sequentially between each of the plurality of user interface screens 110 is performed. At block 526, a check whether release of the continuous touch pattern from the displayed user interface screen 110a is detected. If the release of the touch pattern is not detected, then the process goes to block 524. Else, the process goes to block 528 where the toggling between the plurality of user interface screens 110 is terminated.

### Computer System

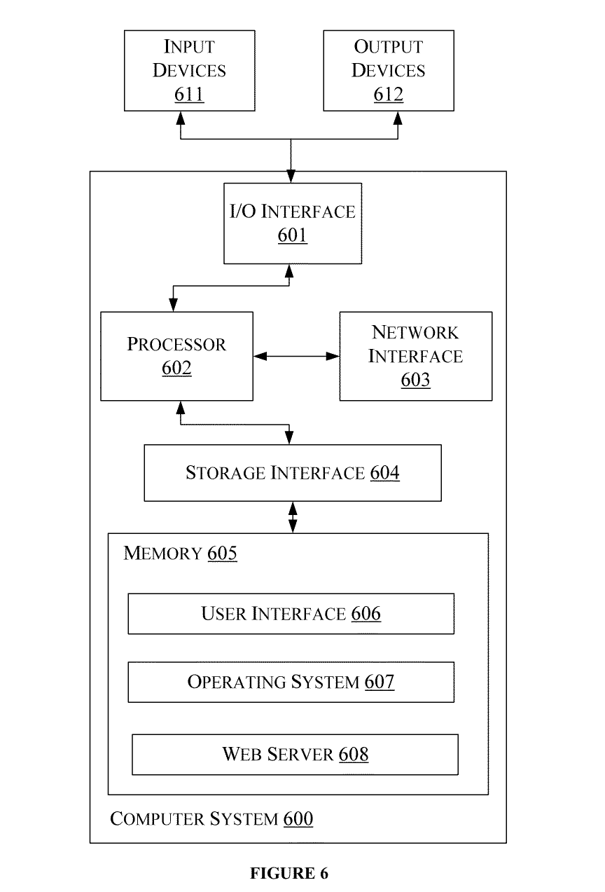

FIG. 6 illustrates a block diagram of an exemplary computer system 600 for implementing embodiments consistent with the present disclosure. In an embodiment, the computer system 600 is used to implement the system 100. The computer system 600 monitors the health condition of a subject. The computer system 600 may comprise a central processing unit (“CPU” or “processor”) 602. The processor 602 may comprise at least one data processor for executing program components for executing user- or device-generated touch pattern. A user may include a person, a person using a device such as those included in this disclosure, or such a device itself. The processor 602 may include specialized processing units such as integrated system (bus) controllers, memory management control units, floating point units, graphics processing units, digital signal processing units, etc.

The processor 602 may be disposed in communication with one or more input/output (I/O) devices (611 and 612) via I/O interface 601. The I/O interface 601 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 601, the computer system 600 may communicate with one or more I/O devices (611 and 612). For example, the input device 611 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 612 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the processor 602 may be disposed in communication with a memory 605 (e.g., RAM, ROM, etc. not shown in FIG. 6) via a storage interface 604. The storage interface 604 may connect to memory 605 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 605 may store a collection of program or database components, including, without limitation, user interface application 606, an operating system 607, web server 608 etc. In some embodiments, computer system 600 may store user/application data 606, such as the data, variables, records, etc. as described in this disclosure. Such databases may be implemented as fault-tolerant, relational, scalable, secure databases such as Oracle or Sybase.

The operating system 607 may facilitate resource management and operation of the computer system 600. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 606 may facilitate display, execution, interaction, manipulation, or operation of program components through textual or graphical facilities. For example, user interfaces may provide computer interaction interface elements on a display system operatively connected to the computer system 600, such as cursors, icons, check boxes, menus, scrollers, windows, widgets, etc. Graphical 3 (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 600 may implement a web browser 608 stored program component. The web browser 608 may be a hypertext viewing application, such as Microsoft Internet Explorer, Google Chrome, Mozilla Firefox, Apple Safari, etc. Secure web browsing may be provided using Secure Hypertext Transport Protocol (HTTPS), Secure Sockets Layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the computer system 600 may implement a mail server stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 600 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, nonvolatile memory, hard drives, CD ROMs, DVDs, flash drives, disks, and any other known physical storage media.

Advantages of the embodiment of the present disclosure are illustrated herein.

Embodiments of the present disclosure enable stacking of user interface screens in different layer in a Z-direction. This enables to store any number of data, applications or elements. Also, Z-direction navigation provides three dimensional navigation with single touch or click.

Embodiments of the present disclosure provide reduces to navigate through intermediate user interface screens to a target user interface screen. This saves energy and time. Also, this provides easy process to navigate to the user interface screens.

Embodiments of the present disclosure perform merging the one or more elements of multiple user interface screens. This saves time to navigate to different user interface screen and providing the required elements in the same user interface screen.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

The illustrated operations of FIG. 5 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for navigating between displayed user interface screens, the method comprising:
sensing, by a touch screen computing device, a touch pattern received from a user on a displayed one of a plurality of user interface screens;
determining, by the touch screen computing device, a touch force, duration, and location of the touch pattern; and
performing, by the touch screen computing device, based on the determination at least one of replacing the displayed user interface screen with one or more of the user interface screens, merging one or more elements of the one or more user interface screens with one or more displayed elements of the displayed user interface screen, or toggling sequentially between the one or more user interface screens.

2. The method as claimed in claim 1, wherein each of the user interface screens is vertically stacked.

3. The method as claimed in claim 1, wherein replacing the displayed user interface screen is performed only when the touch force of the touch pattern is determined to be greater than a predetermined amount of touch force and the duration of the touch pattern is determined to be less than a predetermined amount of time.

4. The method as claimed in claim 3, wherein the merging is performed only when the amount of touch force applied is when the touch force of the touch pattern is determined to be greater than the predetermined amount of touch force, the duration of the touch pattern is determined to be less than a predetermined amount of time, and the location of the touch pattern is determined to be at the one or more displayed elements of the displayed user interface screen.

5. The method as claimed in claim 3, wherein the toggling sequentially between the one or more user interface screens is performed only when the amount of touch force applied is determined to be greater than the predetermined amount of touch force and the duration of the touch pattern is determined to be greater than the predetermined amount of time.

6. The method as claimed in claim 5, wherein the toggling further comprises terminating the toggling upon sensing a release of the touch pattern from the displayed user interface screen.

7. The method as claimed in claim 1, wherein the touch pattern comprises a swipe, slide, poke, tap, press, or gesture.

8. A touch screen computing device comprising at least one processor and a memory coupled to the processor which is configured to be capable of executing programmed instructions comprising and stored in the memory to:
sense a touch pattern received from a user on a displayed one of a plurality of user interface screens;
determine a touch force, duration, and location of the touch pattern; and
perform based on the determination at least one of replacing the displayed user interface screen with one or more of the user interface screens, merging one or more elements of the one or more user interface screens with one or more displayed elements of the displayed user interface screen, or toggling sequentially between the one or more user interface screens.

9. The touch screen computing device as claimed in claim 8, wherein each of the user interface screens is vertically stacked.

10. The touch screen computing device as claimed in claim 8, wherein replacing the displayed user interface screen is performed only when the touch force of the touch pattern is determined to be greater than a predetermined amount of touch force and the duration of the touch pattern is determined to be less than a predetermined amount of time.

11. The touch screen computing device as claimed in claim 10, wherein the merging is performed only when the amount of touch force applied is when the touch force of the touch pattern is determined to be greater than the predetermined amount of touch force, the duration of the touch pattern is determined to be less than a predetermined amount of time, and the location of the touch pattern is determined to be at the one or more displayed elements of the displayed user interface screen.

12. The touch screen computing device as claimed in claim 10, wherein the toggling sequentially between the one or more user interface screens is performed only when the amount of touch force applied is determined to be greater than the predetermined amount of touch force and the duration of the touch pattern is determined to be greater than the predetermined amount of time.

13. The touch screen computing device as claimed in claim 12, wherein the toggling further comprises terminating the toggling upon sensing a release of the touch pattern from the displayed user interface screen.

14. The touch screen computing device as claimed in claim 8, wherein the touch pattern comprises a swipe, slide, poke, tap, press, or gesture.

15. A non-transitory computer readable medium having stored thereon instructions for navigating between displayed user interface screens comprising executable code which when executed, by a processor, causes the processor to perform steps comprising:
sensing a touch pattern received from a user on a displayed one of a plurality of user interface screens;
determining a touch force, duration, and location of the touch pattern; and
performing based on the determination at least one of replacing the displayed user interface screen with one or more of the user interface screens, merging one or more elements of the one or more user interface screens with one or more displayed elements of the displayed user interface screen, or toggling sequentially between the one or more user interface screens.

16. The non-transitory computer readable medium as claimed in claim 15, wherein each of the user interface screens is vertically stacked.

17. The non-transitory computer readable medium as claimed in claim 15, wherein replacing the displayed user interface screen is performed only when the touch force of the touch pattern is determined to be greater than a predetermined amount of touch force and the duration of the touch pattern is determined to be less than a predetermined amount of time.

18. The non-transitory computer readable medium as claimed in claim 18, wherein the merging is performed only when the amount of touch force applied is when the touch force of the touch pattern is determined to be greater than the predetermined amount of touch force, the duration of the touch pattern is determined to be less than a predetermined amount of time, and the location of the touch pattern is determined to be at the one or more displayed elements of the displayed user interface screen.

19. The non-transitory computer readable medium as claimed in claim 18, wherein the toggling sequentially between the one or more user interface screens is performed only when the amount of touch force applied is determined to be greater than the predetermined amount of touch force and the duration of the touch pattern is determined to be greater than the predetermined amount of time.

20. The non-transitory computer readable medium as claimed in claim 19, wherein the toggling further comprises terminating the toggling upon sensing a release of the touch pattern from the displayed user interface screen.

21. The non-transitory computer readable medium as claimed in claim 15, wherein the touch pattern comprises a swipe, slide, poke, tap, press, or gesture.
